(19) United States
(12) Patent Application Publication
(10) Pub. No.: US 2019/0384204 A1
(43) Pub. Date: Dec. 19, 2019

(54) OPTICAL RECORDING DEVICE AND IMAGE FORMING DEVICE

(71) Applicant: Konica Minolta, Inc., Tokyo (JP)

(72) Inventors: Yoshikazu WATANABE, Toyohashi-shi (JP); Sotaro YOKOTA, Toyohashi-shi (JP)

(21) Appl. No.: 16/414,497

(22) Filed: May 16, 2019

(30) Foreign Application Priority Data
Jun. 19, 2018 (JP) 2018-115811

(51) Int. Cl. G03G 15/043; G02B 3/00; H05B 33/08

(52) U.S. Cl. CPC G03G 15/043; H05B 33/0854; H05B 33/0896; G02B 3/0056

(57) ABSTRACT

An optical recording device includes: a lens array in which a plurality of lenses is arranged at least in a main scanning direction; a light emitting element substrate that is arranged in proximity to the lens array, and includes a light emitting element group in which a plurality of light emitting elements forming one pixel is arranged for each lens position of the lens array; and a light emission controller that controls the light emitting elements, wherein, in the light emitting element substrate, at least a light emitting element arranged on an end side in the main scanning direction is a special light emitting element, and the light emission controller is able to adjust an irradiation position irradiated with light from the special light emitting element through the lens array by selectively allowing a plurality of light sources in the special light emitting element to emit light.

The entire disclosure of Japanese patent Application No. 2018-115811, filed on Jun. 19, 2018, is incorporated herein by reference in its entirety.

### BACKGROUND

### Technological Field

The present invention relates to an optical recording device and an image forming device, and especially relates to a technology of arranging a plurality of light emitting elements in a main scanning direction and performing drawing by forming an image of a light beam applied from each light emitting element using a lens array.

### Description of the Related Art

As an optical recording device used in an image forming device, one in which a plurality of light emitting elements is two-dimensionally arranged is conventionally known (for example, JP 11-147326 A). This optical recording device is configured to perform drawing of one pixel by performing multiple exposures using a plurality of light emitting elements.

On the other hand, as an optical recording device used for an electrophotographic type image forming device, there is one which exposes the main scanning direction of a photoreceptor in a drum shape at one time. This type of optical recording device is provided with, for example, a recording head formed of a light emitting element substrate arranged so as to face a surface of the photoreceptor and a microlens array arranged in proximity to the light emitting element substrate. The light emitting element substrate is provided with a plurality of light emitting elements arranged in the main scanning direction. The microlens array is provided with a plurality of lenses arranged in the main scanning direction.

Such optical recording device has an advantage that noise is low because this does not involve mechanical operation as compared with a type in which a single light beam emitted from, for example, a laser light source and the like is deflected to scan using a rotating polygon mirror (polygon mirror) or the like. In addition, since a distance from a light source to the photoreceptor may be reduced, there also is an advantage that space saving may be realized.

However, on the other hand, the recording head is long in the main scanning direction, and a thermal expansion coefficient of the light emitting element substrate a base material of which is a glass substrate is different from a thermal expansion coefficient of the microlens array a base material of which is resin. Therefore, when environmental temperature changes, a position of the lens formed on the microlens array in the main scanning direction and a position of the light emitting element formed on the light emitting element substrate relatively change. That is, distortion occurs in positions of the light emitting element and the lens. As a result, in the conventional optical recording device, there is a problem that the irradiation position of the light beam on a surface of the photoreceptor changes due to the change in environmental temperature, and streak-like drawing unevenness easily occurs.

For example, when the microlens array is connected to the light emitting element substrate in a central position in the main scanning direction, an amount of distortion in the central position of the microlens array is small and an amount of distortion at both ends is large. Therefore, the above-described problem tends to be remarkable at the both ends in the main scanning direction. That is, streak-like unevenness is more noticeable at the both ends in the main scanning direction, which causes deterioration in image quality.

### SUMMARY

The present invention is achieved to solve the above-described conventional problem, and an object thereof is to provide an optical recording device and an image forming device capable of suppressing occurrence of streak-like drawing unevenness even in a case where the environmental temperature changes.

To achieve the abovementioned object, according to an aspect of the present invention, an optical recording device reflecting one aspect of the present invention comprises: a lens array in which a plurality of lenses is arranged at least in a main scanning direction; a light emitting element substrate that is arranged in proximity to the lens array, and includes a light emitting element group in which a plurality of light emitting elements forming one pixel is arranged for each lens position of the lens array; and a light emission controller that controls the light emitting elements provided on the light emitting element substrate, wherein, in the light emitting element substrate, at least a light emitting element arranged on an end side in the main scanning direction out of the light emitting element group arranged in each lens position of the lens array is a special light emitting element formed of a plurality of light sources, and the light emission controller is able to adjust an irradiation position irradiated with light from the special light emitting element through the lens array by selectively allowing the plurality of light sources in the special light emitting element to emit light.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention:

FIG. 1 is a view illustrating a conceptual configuration of an image forming device;

FIG. 2 is an enlarged view of an image forming unit;

FIG. 3 is a view illustrating a configuration example of an optical recording device;

FIGS. 4A to 4C are views illustrating a specific configuration example of an optical system in the optical recording device;

FIG. 5 is a view illustrating a configuration example of a special light emitting element;

FIGS. 6A to 6C are views illustrating an example of changing the number of light sources which should be allowed to emit light and a light emitting position in the special light emitting element;

FIG. 7 is a view illustrating a position in which the special light emitting element is provided;

FIG. 8 is a view illustrating an initial state before a microlens array is displaced by thermal expansion;

FIG. 9 is a view illustrating a state in which the microlens array is displaced;

FIG. 10 is a view illustrating a concept of correction by the special light emitting element;

FIG. 11 is a view illustrating an example in which a light emitting element group is allowed to emit light so as to correct the displacement of the microlens array;

FIG. 12 is a flowchart illustrating a procedure for correcting the displacement of the microlens array; and

FIG. 13 is a view illustrating a concept of correcting lens distortion by adjusting a beam diameter.

### DETAILED DESCRIPTION OF EMBODIMENTS

Hereinafter, one or more embodiments of the present invention will be described with reference to the drawings. However, the scope of the invention is not limited to the disclosed embodiments. Note that, in the embodiments described below, common elements are assigned with the same reference numerals, and the description thereof is not repeated.

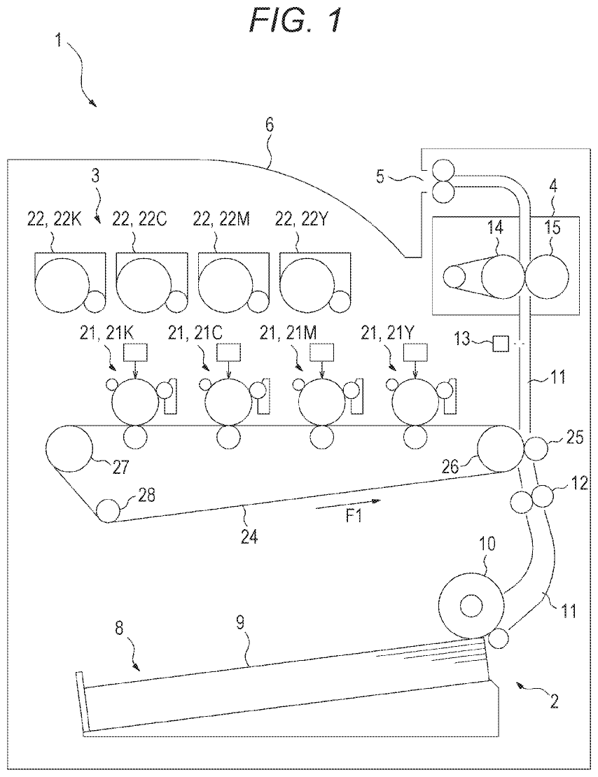

FIG. 1 is a view illustrating a schematic configuration of an image forming device 1 being an embodiment of the present invention. The image forming device 1 is a printer which forms a color image by an electrophotographic method. The image forming device 1 is provided with a paper feeding/conveying unit 2, an image forming unit 3, and a fixing unit 4 in a device main body, and is configured to form a color image or a monochrome image on a sheet-shaped printing medium 9 such as printing paper and discharge the printing medium 9 from a discharge port 5 on an upper portion of the device main body onto a discharge tray 6.

The paper feeding/conveying unit 2 includes a paper feeding cassette 8, a pickup roller 10, a conveyance path 11, a resist roller 12, and a secondary transfer roller 25. The paper feeding cassette 8 accommodates the sheet-shaped printing medium 9 such as the printing paper. The pickup roller 10 is a roller which takes out the printing medium 9 one by one from the paper feeding cassette 8 and conveys the same to the conveyance path 11. The resist roller 12 is a roller which holds a tip end of the printing medium 9 fed from the paper feeding cassette 8 and delivers the printing medium 9 to the secondary transfer roller 25 at a timing synchronized with image forming operation in the image forming unit 3. When the printing medium 9 delivered by the resist roller 12 passes through a position of the secondary transfer roller 25, a toner image primarily transferred to an intermediate transfer belt 24 is secondarily transferred thereto. Then, the paper feeding/conveying unit 2 guides the printing medium 9 to which the toner image is transferred to the fixing unit 4.

The image forming unit 3 is configured to be able to form toner images of four colors of yellow (Y), magenta (M), cyan (C), and black (K) and transfer the toner images of the four colors simultaneously to the printing medium 9 passing through the position of the secondary transfer roller 25. The image forming unit 3 is provided with toner bottles 22 (22Y, 22M, 22C, and 22K) which accommodate toner of respective colors, image forming units 21 (21Y, 21M, 21C, and 21K) which form the toner images of the respective colors, and the intermediate transfer belt 24. The intermediate transfer belt 24 is an endless belt stretched around three rollers 26, 27, and 28, and circularly moves in an arrow μl direction between positions of the four image forming units 21 and the secondary transfer roller 25 by driving of the rollers 26, 27, and 28. All of the image forming units 21Y, 21M, 21C, and 21K of the respective colors are arranged on an upper surface side of the intermediate transfer belt 24 and transfer the toner images to an outer surface of the intermediate transfer belt 24 which circularly moves. The toner bottles 22Y, 22M, 22C, and 22K of the respective colors supply toner to the image forming units 21Y, 21M, 21C, and 21K of the respective colors.

The fixing unit 4 is provided with a heating roller 14 and a pressurizing roller 15, and applies a heating/pressurizing process on the printing medium 9 by passing the printing medium 9 to which the toner image is transferred between the heating roller 14 and the pressurizing roller 15, thereby fixing the toner image on the printing medium 9. The printing medium 9 which passes through the fixing unit 4 so that the toner image is fixed thereon is then discharged from the discharge port 5 onto the discharge tray 6.

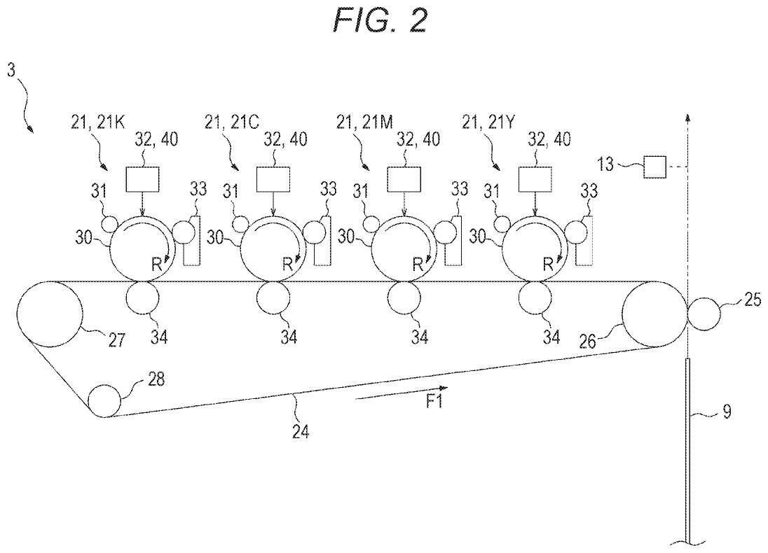

FIG. 2 is an enlarged view of the image forming units 21Y, 21M, 21C, and 21K of the respective colors. The image forming units 21Y, 21M, 21C, and 21K are sequentially arranged from an upstream side of the circularly moving intermediate transfer belt 24, and transfer the toner images of the respective colors to the intermediate transfer belt 24 so as to sequentially overlap. Therefore, at the time of color printing, the toner of Y color, the toner of M color, the toner of C color, and the toner of K color are sequentially primarily transferred to the intermediate transfer belt 24 in this order from an upstream side of the four image forming units 21Y, 21M, 21C, and 21K. Also, at the time of monochrome printing, since the image forming units 21Y, 21M, and 21C of the Y, M, and C colors are not used, only the toner of K color is primarily transferred to the intermediate transfer belt 24 by the image forming unit 21K located on the most downstream.

Each of the image forming units 21Y, 21M, 21C, and 21K includes a photoreceptor 30 in a drum shape, a charging unit 31 which charges a surface of the photoreceptor 30, an exposure device 32 which forms a latent image on the photoreceptor 30 by exposing the surface of the photoreceptor 30, a developing unit 33 which develops the latent image exposed by the exposure device 32 with toner, and a primary transfer roller 34. The photoreceptor 30 rotates in an R direction as illustrated in FIG. 2, and the surface thereof is charged with a predetermined charge when passing through a position of the charging unit 31. When passing through an exposure position by the exposure device 32, the surface of the photoreceptor 30 is irradiated with a light beam. The exposure device 32 is provided as an optical recording device 40. The exposure device 32 is arranged in an axial direction (main scanning direction) of the photoreceptor 30, and may apply a plurality of light beams substantially simultaneously in the main scanning direction of the photoreceptor 30. As a result, the photoreceptor 30 forms an electrostatic latent image at a position irradiated with the light beam by the exposure device 32. The photoreceptor 30 on which the electrostatic latent image is formed is developed with toner when passing through a position of the developing unit 33. Thereafter, the toner image formed on the surface of the photoreceptor 30 is brought into contact with the intermediate transfer belt 24 when passing through a position of the primary transfer roller 34.

The primary transfer roller 34 is arranged so as to interpose the intermediate transfer belt 24 between the same and each of the image forming units 21Y, 21M, 21C, and 21K, and a voltage of a predetermined polarity is applied thereto. Therefore, the primary transfer roller 34 primarily transfers the toner image formed on the surface of the photoreceptor 30 to the intermediate transfer belt 24 by an electrostatic action by bringing the intermediate transfer belt 24 into contact with the surface of the photoreceptor 30 in a state in which the voltage of the predetermined polarity is applied.

The intermediate transfer belt 24 to which the toner image is primarily transferred from each of the image forming units 21Y, 21M, 21C, and 21K as described above is brought into contact with the printing medium 9 when passing through a secondary transfer position where the secondary transfer roller 25 is provided. At that time, a voltage of a predetermined polarity is applied to the secondary transfer roller 25. That is, the secondary transfer roller 25 secondarily transfers the toner images transferred to the surface of the intermediate transfer belt 24 to the printing medium 9 by bringing the printing medium 9 into contact with the intermediate transfer belt 24 at a predetermined contact pressure in a state in which the voltage of the predetermined polarity is applied.

As described above, the exposure device 32 is provided as the optical recording device 40. The optical recording device 40 is individually provided for each of the image forming units 21Y, 21M, 21C, and 21K, and irradiates the surface of the photoreceptor 30 with the light beam on the basis of input image data, thereby forming the electrostatic latent image on the photoreceptor 30.

Also, in this embodiment, an image reading sensor 13 which reads the toner image transferred to the printing medium 9 is provided as an in-line sensor in the conveyance path 11 through which the printing medium 9 to which the toner image is transferred passes at the position of the secondary transfer roller 25. The image reading sensor 13 may be used as an irradiation position detector which detects an irradiation position of the light beam by the optical recording device 40 in a main scanning direction X, and may detect a position to which toner particles of each color are transferred when the printing medium 9 passes through an image reading position (a position in the main scanning direction X). The image reading sensor 13 may feedback a detection result to the optical recording device 40 of each of the image forming units 21Y, 21M, 21C, and 21K.

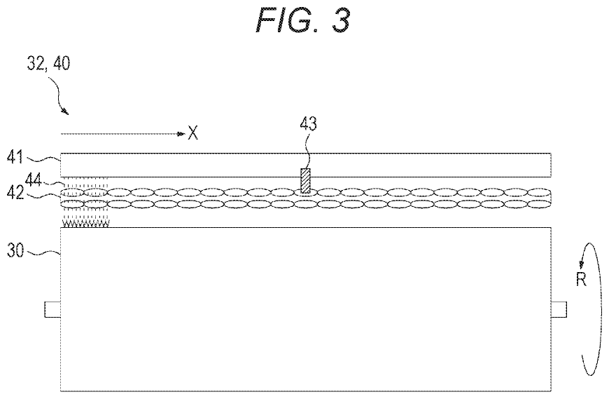

FIG. 3 is a view illustrating a configuration example of the optical recording device 40 in which the main scanning direction X of the photoreceptor 30 is in a lateral direction of the drawing sheet. The optical recording device 40 is provided with a light emitting element substrate 41, a microlens array 42, and a connecting member 43. The light emitting element substrate 41 is obtained by forming a large number of light emitting elements on an elongated glass substrate extending in the main scanning direction X as a base material. The microlens array 42 also is an elongated member extending in the main scanning direction X; for example, this is formed of a resin as a base material on which a large number of microlenses (hereinafter simply referred to as “lenses”) are formed in the main scanning direction X. The connecting member 43 is a member which connects both the light emitting element substrate 41 and the microlens array 42 to each other at a predetermined position in the main scanning direction X. In an example in FIG. 3, the connecting member 43 is attached to central positions in the main scanning direction X of the light emitting element substrate 41 and the microlens array 42, and connects the central positions of the light emitting element substrate 41 and the microlens array 42. In such optical recording device 40, a plurality of light beams 44 is substantially simultaneously applied from the light emitting element substrate 41 in the main scanning direction X, and the microlens array 42 forms an image of the plurality of light beams 44 at a predetermined position in the main scanning direction X, thereby exposing the surface of the photoreceptor 30.

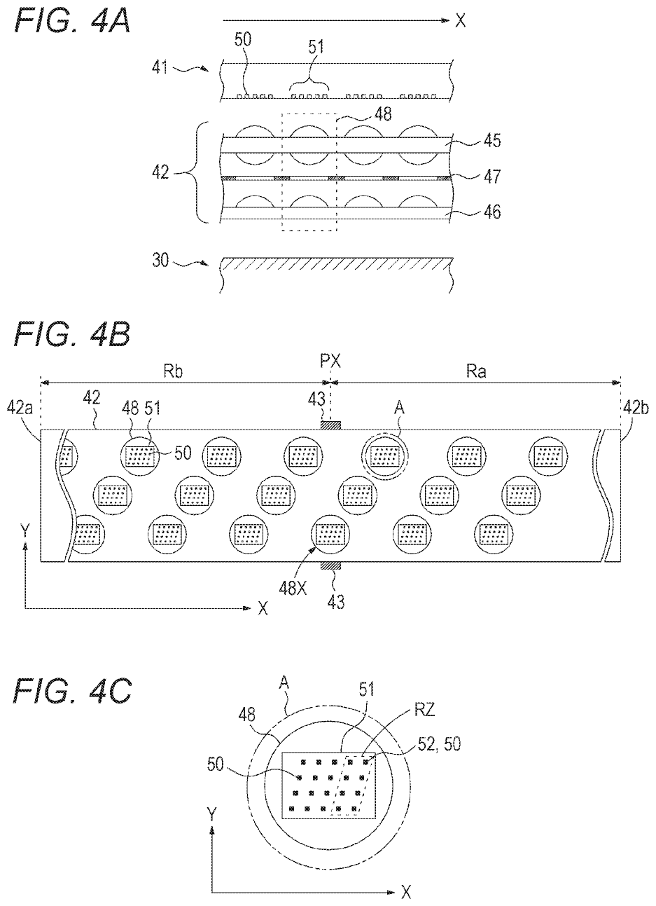

FIGS. 4A to 4C are views illustrating a specific configuration example of an optical system in the optical recording device 40. As illustrated in FIG. 4A, the microlens array 42 includes a first lens plate (G1 lens) 45, a second lens plate (G2 lens) 46, and a diaphragm plate 47. The diaphragm plate 47 is arranged at a lens focal position of the two lens plates of the first lens plate 45 and the second lens plate 46 between the first lens plate 45 and the second lens plate 46. In the microlens array 42, one lens formed on the first lens plate 45, one diaphragm provided on the diaphragm plate 47, and one lens provided on the second lens plate 46 form one image forming lens 48 arranged on one optical axis. The image forming lens 48 is configured as a telecentric optical system. The microlens array 42 has a configuration in which a large number of image forming lenses 48 as described above are formed.

A large number of light emitting elements 50 are formed on the light emitting element substrate 41. The light emitting element 50 is an element forming one pixel in the main scanning direction X when drawing is performed on the surface of the photoreceptor 30, and is formed of, for example, an organic light emitting diode (OLED) or a light emitting diode (LED). Also, on the light emitting element substrate 41, a light emitting element group 51 including a plurality of light emitting elements 50 is arranged for one image forming lens 48 provided on the microlens array 42.

As illustrated in FIG. 4B, a plurality of image forming lenses 48 is two-dimensionally arranged on a surface of the microlens array 42. In an example illustrated in FIG. 4B, the plurality of image forming lens 48 is arranged in a zigzag pattern. That is, an arranging mode is such that a plurality of lines of lens groups in which a plurality of image forming lenses 48 is arranged at predetermined intervals in a line in the main scanning direction X is arranged in a sub scanning direction Y, and a position of the image forming lens 48 in each line is shifted by a predetermined amount in the main scanning direction X. According to such arranging mode, it is possible to arrange the plurality of image forming lenses 48 without a gap in the main scanning direction X. However, the arranging mode of the image forming lenses 48 is not necessarily limited to that illustrated in FIG. 4B. Then, in the light emitting element substrate 41, the light emitting element group 51 including the plurality of light emitting elements 50 is arranged at a position corresponding to each of the image forming lenses 48.

FIG. 4C is an enlarged view of the image forming lens 48 and the light emitting element group 51 at a position of a portion A illustrated in FIG. 4B. As illustrated in FIG. 4C, the light emitting element group 51 arranged corresponding to one image forming lens 48 is provided with the plurality of light emitting elements 50 two-dimensionally arranged in a plane defined by the main scanning direction X and the sub scanning direction Y. An example illustrated in FIG. 4C illustrates an example in which a plurality of light emitting elements 50 is arranged in a zigzag pattern. That is, an arranging mode is such that a plurality of lines of light emitting element groups in which a plurality of light emitting elements 50 is arranged at predetermined intervals in a line in the main scanning direction X is arranged in the sub scanning direction Y, and a position of the light emitting element 50 in each line is shifted by a predetermined amount in the main scanning direction X. According to such an arranging mode, it is possible to arrange a plurality of light emitting elements without a gap in the main scanning direction X. However, the arranging mode of the light emitting element 50 is not necessarily limited to that illustrated in FIG. 4C.

The image forming lens 48 in the portion A illustrated in FIG. 4B is located in a region Ra to the right of a reference position PX where the connecting member 43 is provided, in a position closer to a right side end 42b out of left and right ends 42a and 42b of the microlens array 42. Therefore, as illustrated in FIG. 4C, in the light emitting element group 51 arranged inside the image forming lens 48 of the portion A, the light emitting element 50 arranged in a region RZ on a side closer to the right side end 42b of the microlens array 42 is made a special light emitting element 52.

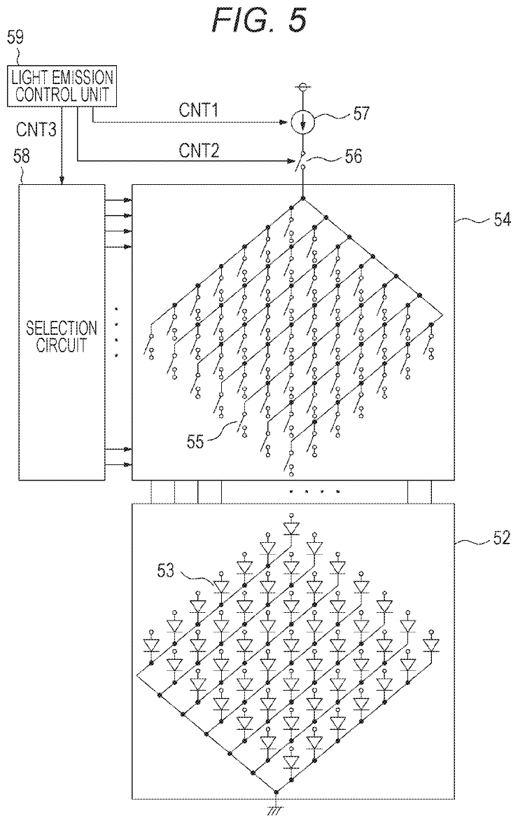

FIG. 5 is a view illustrating a configuration example of the special light emitting element 52. The special light emitting element 52 is a light emitting element provided with a plurality of light sources 53 having a configuration in which the plurality of light sources 53 is two-dimensionally arranged in a matrix pattern. The special light emitting element 52 may select the number of light emission from the plurality of light sources 53 and a position thereof and allow the same to emit. FIG. 5 illustrates a case of including a total of 49 light sources 53 arranged in a 7×7 matrix pattern. However, the number of light sources 53 forming the special light emitting element 52 is not limited to this. For example, if a matrix configuration is 6×6, the number of light sources 53 may be made 39, and if the matrix configuration is 8×8, the number of light sources 53 may be made 64.

As illustrated in FIG. 5, the special light emitting element 52 is controlled by a switch circuit 54, an on/off circuit 56, a current source 57, a selection circuit 58, and a light emission control unit 59.

The switch circuit 54 is a circuit including switches 55 as many as the number of light sources 53 forming the special light emitting element 52 and is able to individually turning on/off each switch 55. The switch circuit 54 may select at least one light source 53 from the plurality of light sources 53 and allows the same to emit light by individually turning on/off the plurality of switches 55.

The current source 57 is a power supply circuit which outputs current to be supplied to the special light emitting element 52. The current source 57 outputs current based on a control signal CNT1 output from the light emission control unit 59. That is, the current source 57 may adjust the current supplied to the special light emitting element 52 based on the control signal CNT1.

The on/off circuit 56 is a circuit which supplies/shuts the current to the special light emitting element 52. The on/off circuit 56 supplies/shuts the current output from the current source 57 to the special light emitting element 52 based on a control signal CNT2 output from the light emission control unit 59.

The selection circuit 58 is a circuit which outputs control signals for individually turning on/off each of the plurality of switches 55 provided on the switch circuit 54. The selection circuit 58 turns on/off each switch 55 provided on the switch circuit 54, thereby selecting at least one light source 53 from the plurality of light sources 53 provided on the special light emitting element 52 to allow the same to emit light. The selection circuit 58 determines the number of light sources 53 which should be allowed to emit light in the special light emitting element 52 and a position thereof based on a control signal CNT3 output from light emission control unit 59, and individually turns on/off the switches 55 of the switch circuit 54 in order to allow at least one light source 53 in the special light emitting element 52 to emit light on the basis of the determination.

The light emission control unit 59 performs light emission control of each of the plurality of light sources 53 provided in the special light emitting element 52. The light emission control unit 59 adjusts the current supplied to the special light emitting element 52 by outputting the control signal CNT1 to the current source 57. By this current adjustment, density per pixel may be adjusted. The light emission control unit 59 may also control exposure operation by the special light emitting element 52 by outputting the control signal CNT2 to the on/off circuit 56, and control an exposure state of the pixel corresponding to the special light emitting element 52. Furthermore, the light emission control unit 59 outputs the control signal CNT3 to the selection circuit 58, thereby controlling the number of light sources 53 which should be allowed to be emit light in the special light emitting element 52 and the light emitting position thereof. As a result, an irradiation position and a beam size of the light beam applied from the special light emitting element 52 may be adjusted.

The optical recording device 40 according to this embodiment is configured to perform the light emission control of the special light emitting element 52, thereby suppressing streak-like drawing unevenness which might occur due to an influence of environmental temperature. That is, the optical recording device 40 adjusts the number of light sources 53 which should be allowed to emit light in the special light emitting element 52 and the light emitting positions thereof, thereby adjusting such that there is no portion not exposed on the surface of the photoreceptor 30 in the main scanning direction X.

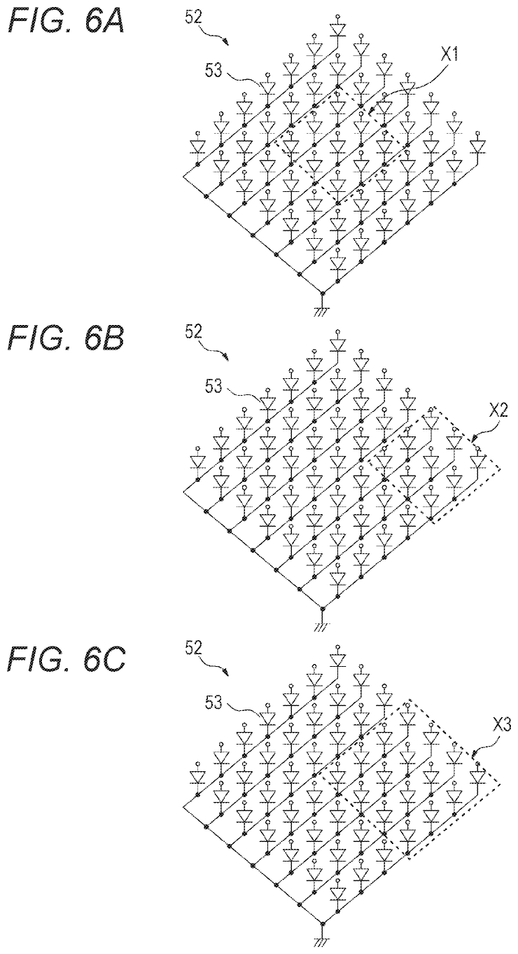

FIGS. 6A to 6C are views illustrating an example in which the number of light sources 53 which should be allowed to emit light in the special light emitting element 52 and the light emitting position thereof are changed. FIG. 6A is an example illustrating an initial state when the special light emitting element 52 is allowed to emit light. As illustrated in FIG. 6A, in the initial state, the special light emitting element 52 allows nine light sources 53 located in a central region X1 out of the plurality of light sources 53 arranged in a matrix pattern to emit light. That is, in the initial state, the special light emitting element 52 exposes the photoreceptor 30 by one pixel by allowing the nine light sources 53 illustrated in FIG. 6A to emit light.

On the other hand, FIG. 6B is a view illustrating an example in which the light emitting position in the special light emitting element 52 is changed from the initial state. For example, as illustrated in FIG. 6B, the special light emitting element 52 may allow nine light sources 53 located in an end region X2 of the matrix out of the plurality of light sources 53 arranged in the matrix pattern to emit light. In this case, as compared with the initial state illustrated in FIG. 6A, the light emitting position in the special light emitting element 52 is changed. As a result, the irradiation position at which the light beam from the special light emitting element 52 is applied to the surface of the photoreceptor 30 through the image forming lens 48 changes. Then, by changing the light emitting position in the special light emitting element 52 in the main scanning direction X, the irradiation position of the light beam applied to the photoreceptor 30 may be moved in a direction opposite to a moving direction of the light emitting position in the main scanning direction X.

Also, FIG. 6C is a view illustrating an example in which the number of light sources 53 allowed to emit light is further increased from the state in FIG. 6B. For example, as illustrated in FIG. 6C, the special light emitting element 52 may allow 16 light sources 53 located in an end region X3 of the matrix out of the plurality of light sources 53 arranged in the matrix pattern to emit light. In this case, the beam diameter of the light beam applied from the special light emitting element 52 is larger than that in the light emitting state illustrated in FIG. 6B. As a result, an irradiation range when the light beam from the special light emitting element 52 is applied to the surface of the photoreceptor 30 through the image forming lens 48 is expanded. Therefore, by adjusting the number of light sources 53 allowed to emit light in the special light emitting element 52, the beam diameter of the light beam applied to the photoreceptor 30 may be increased or decreased.

In this embodiment, not all the light emitting elements 50 arranged inside the image forming lens 48 are made the special light emitting elements 52 described above, but only a part of the light emitting elements 50 located on a side closer to the end 42a or 42b of the microlens array 42 are made the above-described special light emitting element 52.

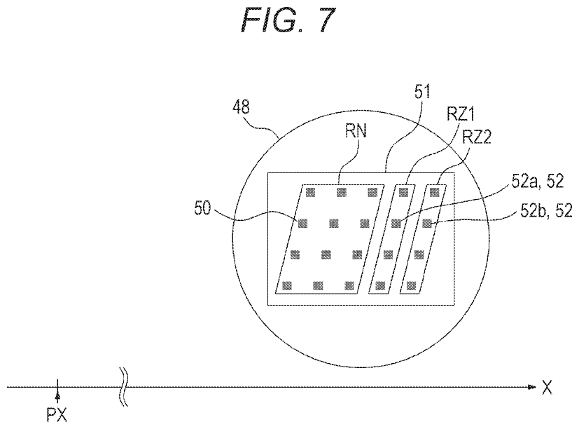

FIG. 7 is a view illustrating a position at which the special light emitting element 52 is provided. FIG. 7 illustrates a case where a right portion of the image forming lens 48 is close to the right side end 42b of the microlens array 42 and a left portion of the image forming lens 48 is close to the center of the microlens array 42. For example, as illustrated in FIG. 4B, the connecting member 43 is provided at the central position of the microlens array 42, and when the microlens array 42 is thermally expanded, an amount of displacement increases with a distance from the reference position PX where the connecting member 43 is provided. Therefore, in a case of the image forming lens 48 located to the right of the reference position PX, as illustrated in FIG. 7, in the light emitting element group 51, a normal light emitting element 50 is arranged in a region RN close to the center of the microlens array 42 (that is, a left region of the image forming lens 48). The normal light emitting element 50 is, for example, the light emitting element in which the nine light sources 53 described above are arranged and the nine light sources 53 are allowed to simultaneously turn on/off. That is, the normal light emitting element 50 is arranged in a region closer to the reference position PX in the region corresponding to the image forming lens 48. On the other hand, the special light emitting element 52 is arranged in regions RZ1 and RZ2 (that is, a right side region of the image forming lens 48) closer to the right side end 42b of the microlens array 42. That is, the special light emitting element 52 is arranged in the region away from the reference position PX in the region corresponding to the image forming lens 48.

In this manner, by forming only a part of the light emitting elements 50 as the special light emitting elements 52 out of the light emitting element group 51 arranged corresponding to one image forming lens 48, a circuit scale may be made smaller than in a case where all the light emitting elements 50 are made the special light emitting elements 52.

Also, comparing the two regions RZ1 and RZ2 in FIG. 7, it may be said that the region RZ2 is farther from the reference position PX than the region RZ1. Therefore, the special light emitting element 52 arranged in the region RZ1 and the special light emitting element 52 arranged in the region RZ2 may be configured differently. For example, special light emitting elements 52a arranged in the region RZ1 may have a 7×7 matrix configuration, and special light emitting elements 52b arranged in the region RZ2 may have an 8×8 matrix configuration. That is, as the distance from the reference position PX increases, the matrix size of the special light emitting element 52 is increased. By increasing the matrix size, the number of selectable light sources 53 may be increased, and an amount of movement of the light beam and an amount of adjustment of the beam diameter by the special light emitting element 52 may be increased.

The same applies to a plurality of image forming lenses 48 provided at different positions in the main scanning direction X. That is, it is preferable to increase the matrix size of the special light emitting element 52 in the light emitting element group 51 provided corresponding to the image forming lens 48 as a distance between the image forming lens 48 and the reference position PX increases. As a result, as the distance from the reference position PX increases, the amount of movement of the light beam and the amount of adjustment of the beam diameter by the special light emitting element 52 may be increased, so that distortion due to expansion of the microlens array 42 may be appropriately corrected.

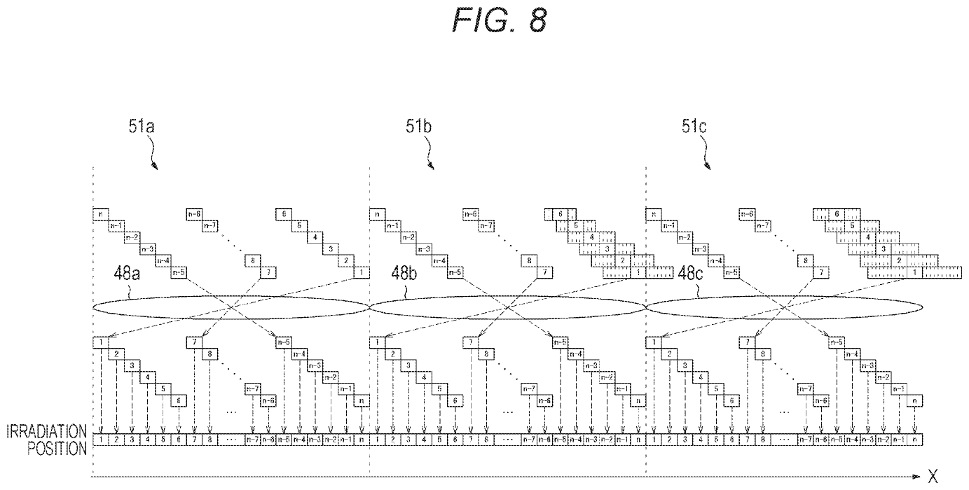

FIG. 8 is a view illustrating the initial state before the microlens array 42 is displaced by the thermal expansion. In FIG. 8, three image forming lenses 48a, 48b, and 48c in positions adjacent to one another in the main scanning direction X are illustrated. However, the three image forming lenses 48a, 48b, and 48c are not necessarily at the same position in the sub scanning direction Y. In the example illustrated in FIG. 8, light emitting element groups 51a, 51b, and 51c each of which is formed of n light emitting elements 50 for n pixels are provided corresponding to the respective image forming lenses 48a, 48b, and 48c. In the initial state before the microlens array 42 is relatively displaced with respect to the light emitting element substrate 41, the light beam applied from each of the light emitting elements in the light emitting element groups 51a, 51b, and 51c is applied to a predetermined irradiation position by each of the image forming lenses 48a, 48b, and 48c. That is, in the initial state, as illustrated in FIG. 8, the light beam from each light emitting element 50 is applied to the surface of the photoreceptor 30 without a gap in the main scanning direction X.

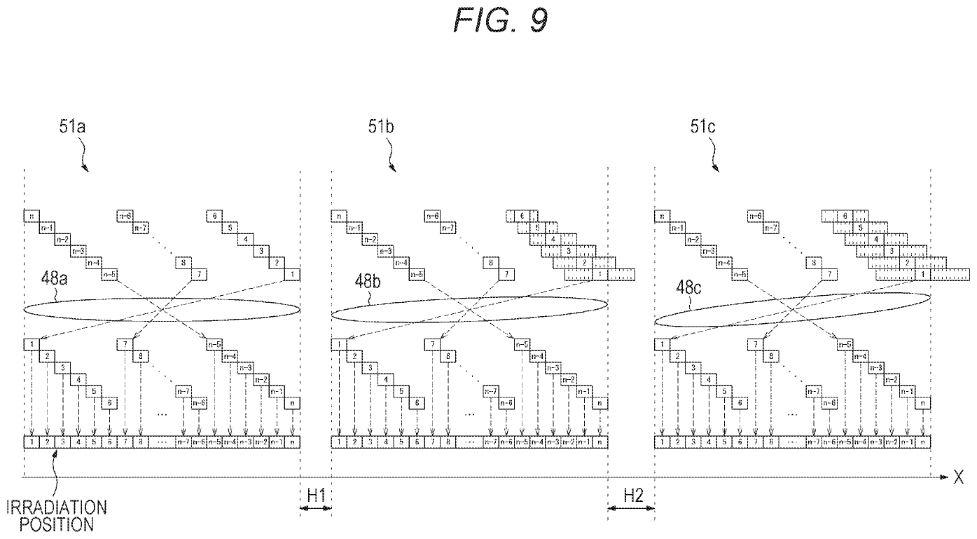

FIG. 9 is a view illustrating a state in which the microlens array 42 is displaced. Note that FIG. 9 illustrates a case where the image forming lens 48a among the three image forming lenses 48a, 48b, and 48c is a reference lens 48X (refer to FIG. 4B) provided at the reference position PX. When the microlens array 42 is thermally expanded due to a change in environmental temperature or the like, the microlens array 42 expands in a direction to right and left in the main scanning direction X based on the reference position PX. Therefore, except for the image forming lens 48a which is the reference lens 48X, the image forming lenses 48b and 48c at positions away from the reference position PX are relatively displaced with respect to the light emitting element substrate 41. The relatively displaced state is illustrated in FIG. 9.

In a state in which the image forming lenses 48b and 48c are displaced relative to the light emitting element substrate 41 as illustrated in FIG. 9, when the control similar to that in the initial state illustrated in FIG. 8 is performed as the light emission control for the image forming lenses 48b and 48c, it becomes not possible to apply the light beams applied from the respective light emitting elements 50 without gap in the main scanning direction X as illustrated in FIG. 9. That is, as illustrated in FIG. 9, a gap H1 not irradiated with the light beam is generated between the image forming lenses 48a and 48b, and a gap H2 not irradiated with the light beam is generated between the image forming lenses 48b and 48c. The gaps H1 and H2 become larger as the distance from the reference position PX becomes larger, and when this become a predetermined gap or larger, streak-like drawing unevenness occurs to cause image quality deterioration.

Therefore, in this embodiment, out of the light emitting element group 51 arranged corresponding to each of the image forming lenses 48b and 48c, the light emitting element 50 located on the end side in the main scanning direction X is made the special light emitting element 52, and by selecting the light source 53 which should be allowed to emit light out of the plurality of light sources 53 and allowing the same to emit light, the gaps H1 and H2 are corrected so as not to be at least visually noticeable. For example, the above-described image reading sensor 13 detects the above-described gaps H1 and H2 by detecting a region to which toner particles are not transferred in the main scanning direction X. Then, the image reading sensor 13 outputs information regarding the gaps H1 and H2 (for example, information regarding widths of the gaps H1 and H2) to the light emission control unit 59 described above. The light emission control unit 59 determines the light emitting position and the number of light emission of the light sources 53 which should be allowed to emit light in the special light emitting element 52 on the basis of the information regarding the gaps H1 and H2 obtained from the image reading sensor 13, thereby correcting such that the streak-like drawing unevenness by the gaps H1 and H2 are not noticeable.

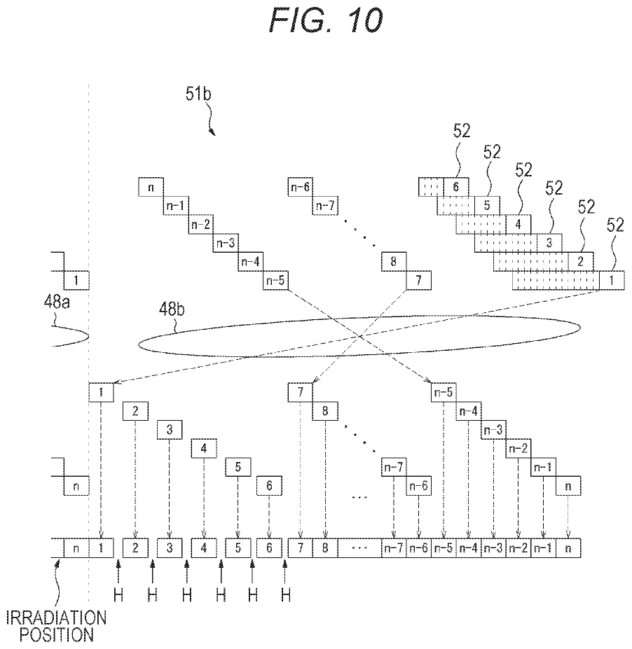

FIG. 10 is a view illustrating a concept of the correction by the special light emitting element 52. As illustrated in FIG. 10, in the light emitting element group 51b arranged corresponding to the image forming lens 48b, the light emitting elements 50 arranged on the end side in the main scanning direction X are configured as the special light emitting elements 52. When detecting that the gap H1 not irradiated with the light beam is generated between the image forming lenses 48a and 48b as illustrated in FIG. 9, the light emission control unit 59 selects the light source 53 (light source 53 at a position far from the reference position PX) located on the end side of the main scanning direction X from the plurality of light sources 53 in the special light emitting element 52 of the light emitting element group 51b provided corresponding to the image forming lens 48b and allows the same to emit light. For example, in a case in FIG. 10, first to sixth pixels are configured as the special light emitting elements 52. Therefore, when the special light emitting elements 52 corresponding to the first to sixth pixels are allowed to emit light, the light source 53 on an outer side in the main scanning direction X is selected and allowed to emit light. As a result, the irradiation positions of the light beams from the special light emitting elements 52 corresponding to the first to sixth pixels are moved to positions of the above-described gap H1, as illustrated in FIG. 10. That is, by moving the light emitting position of the special light emitting element 52 outward in the main scanning direction X, the gap H1 is filled.

For example, when the number of light sources 53 for allowing the special light emitting element 52 to emit light in the initial state is nine and the number of light sources 53 allowed to emit light by the correction is also nine as illustrated in FIG. 10, the beam diameter of the light beam is the same, so that the irradiation position of the light beam merely moves to a position closer to the reference position PX. Therefore, as illustrated in FIG. 10, there still is the gap H between the first pixel and the second pixel. Similarly, the gap H is also generated between another pixel and the pixel adjacent to the same. However, since the gap H illustrated in FIG. 10 is smaller than the gap H1 illustrated in FIG. 9, it becomes visually unnoticeable and deterioration in image quality may be suppressed. Note that, although the light emitting element group 51b provided corresponding to the image forming lens 48b is described in FIG. 10, the other image forming lenses 48c and the like are similar to this.

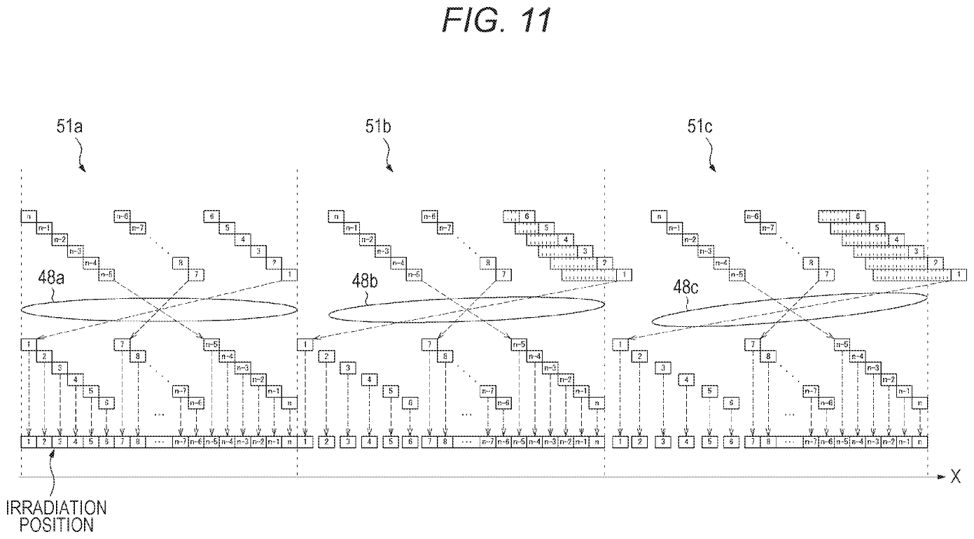

FIG. 11 is a view illustrating an example in which the light emitting element groups 51b and 51c are allowed to emit light so as to correct the displacement of the microlens array 42. As illustrated in FIG. 11, when the special light emitting elements 52 of the light emitting element group 51b provided corresponding to the image forming lens 48b are allowed to emit light as described above, and the special light emitting elements 52 of the light emitting element group 51c provided corresponding to the image forming lens 48c are allowed to emit light as described above, the beam irradiation positions of the first to sixth pixels out of a plurality of pixels provided corresponding to the image forming lenses 48b and 48c move to the positions closer to the reference position PX in the main scanning direction X as illustrated in FIG. 11. It may be understood that the gaps H1 and H2 illustrated in FIG. 9 become smaller in FIG. 11 by such movement of the beam irradiation position. As a result, the streak-like drawing unevenness is corrected so as not to be visually noticeable.

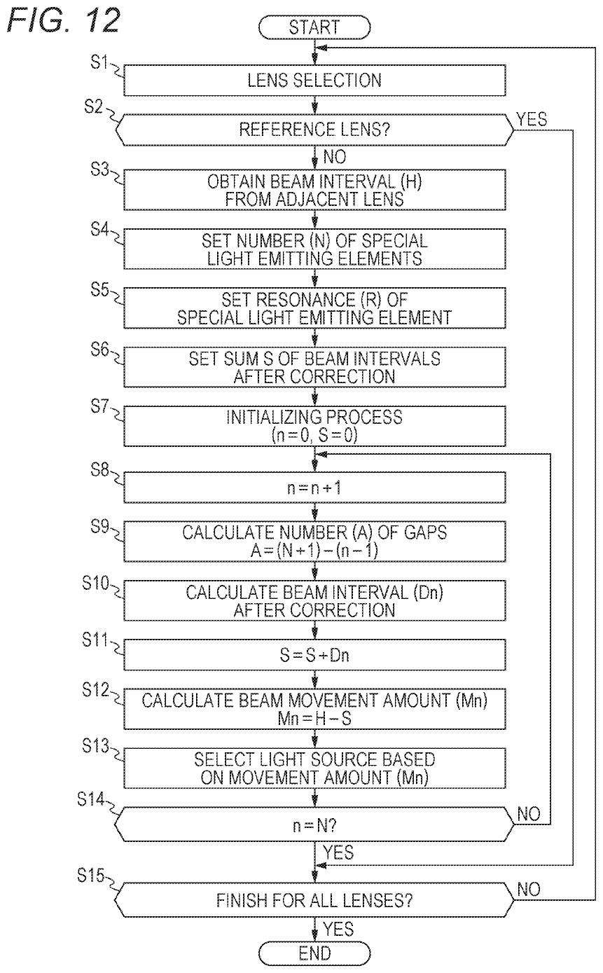

Next, FIG. 12 is a flowchart illustrating a procedure for performing the above-described correction. This process is a process performed based on a program when the light emission control unit 59 described above executes a predetermined program.

When starting this process, the light emission control unit 59 first selects one image forming lens 48 to be corrected from a plurality of image forming lenses 48 provided on the microlens array 42 (step S1). The light emission control unit 59 determines whether the selected image forming lens 48 is the reference lens 48X at the reference position PX (step S2). In a case where the selected image forming lens 48 is the reference lens 48X (YES at step S2), it is considered that there is no displacement due to thermal expansion, and processes at steps S3 to S14 are skipped. In this case, the process by the light emission control unit 59 jumps to step S15.

On the other hand, in a case where the selected image forming lens 48 is a lens different from the reference lens 48X (NO at step S2), the light emission control unit 59 determines that the correction is necessary, and sets the selected image forming lens 48 as a lens to be corrected. Then, based on the output from the image reading sensor 13, the light emission control unit 59 obtains a beam interval (H) generated between the same and the image forming lens 48 adjacent in the main scanning direction X. This beam interval (H) is the gap (H1 or H2) illustrated in FIG. 9. Then, the light emission control unit 59 sets the number (N) of special light emitting elements 52 provided corresponding to the correction target lens (step S4). For example, in a case where the light emitting elements 50 for six pixels from the first to sixth pixels are the special light emitting elements 52 as illustrated in FIG. 10, N=6 is set at step S4.

Subsequently, the light emission control unit 59 sets resolution (R) of the special light emitting element 52 (step S5). The resolution (R) is determined by a size of the light source 53 forming the special light emitting element 52. For example, in a case where the size of one light source 53 in the special light emitting element 52 is 10 μm, the resolution R is set to 10 μm. Furthermore, the light emission control unit 59 sets the sum (S) of the beam intervals after correction (step S6). The sum (S) of the beam intervals is the sum of the beam intervals which may be corrected by moving the light emitting positions of the N special light emitting elements 52. Then, the light emission control unit 59 initializes a variable n to 0 and initializes the sum S of the beam intervals to 0 (step S7).

Next, the light emission control unit 59 performs a loop process for selecting the light source 53 which should be allowed to emit light for each of the N special light emitting elements 52 (steps S8 to S14). That is, the light emission control unit 59 first adds one to the variable n (step S8). Then, the light emission control unit 59 calculates the number (A) of gaps generated between the N special light emitting elements 52 (step S9). That is, the number (A) of gaps is calculated by A=(N+1)−(n−1). Next, the light emission control unit 59 calculates a beam interval (Dn) after correction of the n-th pixel (step S10). The beam interval (Dn) is calculated by following equation (1).

$$Dn = \{ \frac{\frac{P - S}{A}}{R} \} \times R \qquad [ Equation 1 ]$$

Next, the light emission control unit 59 updates the value of the sum S of the beam intervals after correction by the special light emitting element 52 of the n-th pixel (step S11). That is, the value of the beam interval Dn calculated at step S10 is added to the sum S of the beam intervals. Then, the light emission control unit 59 calculates a movement amount (Mn) by which the irradiation position of the light beam of the n-th pixel is moved (step S12). The movement amount Mn is calculated by Mn=H−S. Then, the light emission control unit 59 selects the light source 53 which should be allowed to emit light in the special light emitting element 52 based on the movement amount Mn calculated at step S12 (step S13). As a result, in the special light emitting element 52 corresponding to the n-th pixel, it is possible to determine the light source 53 which should be allowed to emit light out of the plurality of light sources 53.

Next, the light emission control unit 59 determines whether the variable n is N (step S14), and in a case where the variable n does not coincide with N (NO at step S14), the procedure returns to step S8 and the above-described process is repeated. As a result, it is possible to determine the light source 53 which should be allowed to emit light for each of the N special light emitting elements 52 provided corresponding to the lens to be corrected. In a case where the variable n coincides with N (YES at step S14), the light emission control unit 59 determines whether the above-described process is completed for all the image forming lenses 48 provided on the microlens array 42 (step S15). When the above-described process is completed for all the image forming lenses 48 provided on the microlens array 42, correction for all pixels in the main scanning direction X recorded by the optical recording device 40 is completed, so that the procedure in FIG. 12 is completed. The process described above is repeatedly executed while the exposure operation by the optical recording device 40 is performed. Therefore, when the environmental temperature changes and distortion occurs in the image forming lens 48, the distortion may be corrected in real time, and generation of the streak-like drawing unevenness may be suppressed.

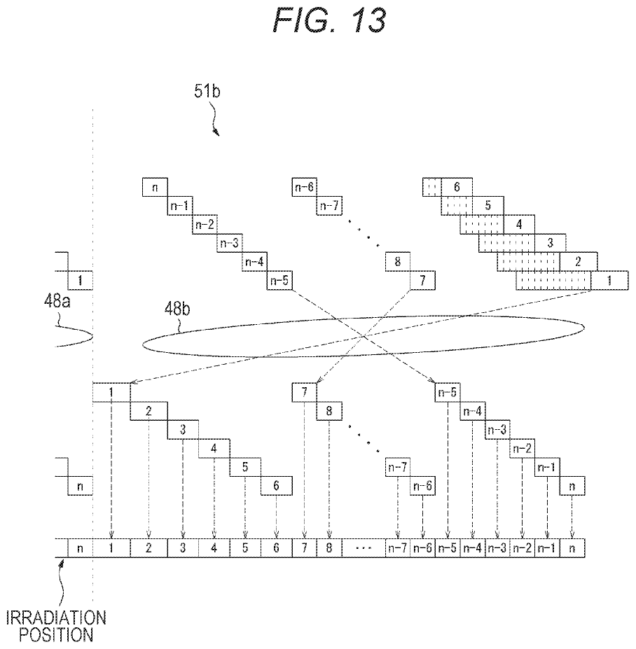

Next, FIG. 13 is a view illustrating a concept of correcting the distortion of the image forming lens 48 by further adjusting the beam diameter. As illustrated in FIG. 13, in the light emitting element group 51b arranged corresponding to the image forming lens 48b, the light emitting element 50 arranged on the end side in the main scanning direction X is configured as the special light emitting element 52. When detecting that the gap H1 not irradiated with the light beam is generated between the image forming lenses 48a and 48b as illustrated in FIG. 9, as described later, the light emission control unit 59 selects the light source 53 (light source 53 at a position far from the reference position PX) located on the end side of the main scanning direction X from the plurality of light sources 53 in the special light emitting element 52 of the light emitting element group 51b provided corresponding to the image forming lens 48b and allows the same to emit light. At that time, the light emission control unit 59 may move the beam irradiation position in a state in which the beam diameter is increased by increasing the number of light sources 53 allowed to emit light in the special light emitting element 52 from the initial state. As a result, as illustrated in FIG. 11, the beam may be applied without the gap between the adjacent pixels at the irradiation position after the correction. That is, in the example illustrated in FIG. 10, the gap H is still generated between the adjacent pixels, but by increasing the beam diameter, it becomes possible to expose the surface of the photoreceptor 30 in a state in which such gap H is not generated. Therefore, in this case, deterioration in image quality may be suppressed better than that in the correction of merely moving the beam irradiation position.

In addition to the above, for example, the light emission control unit 59 may correct the gap H illustrated in FIG. 10 so as not to be noticeable by controlling the current source 57 to increase the current supplied to the special light emitting element 52. That is, when the current supplied to the special light emitting element 52 increases, the amount of light applied from each light source 53 of the special light emitting element 52 increases, and toner density at the time of toner transfer increases accordingly. The light emission control unit 59 adjusts the toner density by adjusting the amount of light of the special light emitting element 52. Since the image may be drawn such that the gap H is not noticeable even by increasing the toner density, it is useful as a method for suppressing the deterioration in image quality. The method of increasing the current in the light emission control unit 59 may be adopted together with the method of increasing the beam diameter illustrated in FIG. 13.

As described above, the optical recording device 40 of this embodiment is provided with a microlens array 42 in which a plurality of lenses is arranged at least in a main scanning direction, a light emitting element substrate 41 arranged in proximity to the microlens array 42 including a light emitting element group 51 in which a plurality of light emitting elements 50 forming one pixel is arranged for each lens position of the microlens array 42, and a light emission control unit 59 that controls the light emitting elements 50 provided on the light emitting element substrate 41. In the light emitting element substrate 41, at least the light emitting element 50 arranged on the end side (end side away from the reference position PX) in the main scanning direction X out of the light emitting element group 51 arranged in each lens position of the microlens array 42 is configured as the special light emitting element 52 provided with a plurality of light sources 53. In such a configuration, the light emission control unit 59 selectively allows a plurality of light sources 53 in the special light emitting element 52 to emit light, thereby adjusting the irradiation position to which the light beam from the special light emitting element 52 is applied through the microlens array 42.

According to the configuration as described above, the circuit scale is reduced as compared with the case where all of the plurality of light emitting elements 50 provided corresponding to each lens position of the microlens array 42 are provided as the special light emitting elements 52, so that there is an advantage that the optical recording device 40 may be easily miniaturized. In addition, even in a case where the environmental temperature changes, the beam irradiation position in the main scanning direction X may be corrected to reduce the gap generated between the adjacent beams, so that it is possible to draw such that the streak-like drawing unevenness is not noticeable. Therefore, there is an advantage that the deterioration in image quality due to the change in environmental temperature may be suppressed.

### VARIATION

Several embodiments of the present invention are described above. However, the present invention is not limited to the contents described in the above embodiments, and various variations may be applied.

For example, although the case where the image forming device 1 is configured as a printer is exemplified in the above embodiment, the present invention is not limited to this. For example, the image forming device 1 may be configured as a device having a plurality of functions such as Multifunction Peripherals (MFP), and a printer function may be installed as one of the plurality of functions.

In the above-described embodiment, the example is described in which the image reading sensor 13 reads the toner image after the toner image is transferred to the printing medium 9 to detect the irradiation position of the light beam by the optical recording device 40. However, the irradiation position detector that detects the irradiation position of the light beam by the optical recording device 40 is not necessarily limited to the image reading sensor 13 described above. For example, a sensor for detecting the irradiation position of the light beam may be arranged in proximity to the intermediate transfer belt 24. Alternatively, a sensor for detecting the irradiation position of the light beam may be arranged in proximity to the photoreceptor 30 of each of the image forming units 21Y, 21M, 21C, and 21K.

Although embodiments of the present invention have been described and illustrated in detail, the disclosed embodiments are made for purposes of illustration and example only and not limitation. The scope of the present invention should be interpreted by terms of the appended claims.

What is claimed is:

1. An optical recording device comprising:
a lens array in which a plurality of lenses is arranged at least in a main scanning direction;
a light emitting element substrate that is arranged in proximity to the lens array, and includes a light emitting element group in which a plurality of light emitting elements forming one pixel is arranged for each lens position of the lens array; and
a light emission controller that controls the light emitting elements provided on the light emitting element substrate,
wherein, in the light emitting element substrate, at least a light emitting element arranged on an end side in the main scanning direction out of the light emitting element group arranged in each lens position of the lens array is a special light emitting element formed of a plurality of light sources, and
the light emission controller is able to adjust an irradiation position irradiated with light from the special light emitting element through the lens array by selectively allowing the plurality of light sources in the special light emitting element to emit light.

2. The optical recording device according to claim 1, wherein the special light emitting element is a matrix light emitting element in which a plurality of light sources is arranged in a matrix pattern.

3. The optical recording device according to claim 1, further comprising
an irradiation position detector that detects the irradiation position,
wherein the light emission controller selects a light source which should be allowed to emit light out of the plurality of light sources in the special light emitting element based on a detection result of the irradiation position detector.

4. The optical recording device according to claim 1,
wherein, in the light emitting element substrate, a plurality of light emitting elements out of the light emitting element group arranged in each lens position of the lens array is formed as special light emitting elements, and
out of the plurality of special light emitting elements arranged for the same lens position, a special light emitting element located on an end side in the main scanning direction has the number of light sources selectable larger than the number of light sources selectable of the special light emitting element located on a central side.

5. The optical recording device according to claim 1, wherein the light emitting element substrate uses a predetermined position of the lens array in the main scanning direction as a reference position, and as the lens position of the lens array is away from the reference position, the number of light sources of the special light emitting element arranged in the lens position increases.

6. The optical recording device according to claim 5, wherein the reference position is a central position of the lens array in the main scanning direction.

7. The optical recording device according to claim 5, further comprising
a connecting member that connects the lens array to the light emitting element substrate in a predetermined position in the main scanning direction,
wherein the reference position is a position in which the connecting member is provided.

8. The optical recording device according to claim 1, wherein the light emission controller is able to adjust a light amount when selecting a light source which should be allowed to emit light out of the plurality of light sources included in the special light emitting element and allowing the light source to emit light.

9. The optical recording device according to claim 1, wherein the light emission controller is able to adjust the number of light sources allowed to emit light when selecting a light source which should be allowed to emit light out of the plurality of light sources included in the special light emitting element.

10. An image forming device comprising:
the optical recording device according to claim 1;
a photoreceptor on which a latent image is formed by the optical recording device;
a developer that develops the latent image formed on the photoreceptor; and
a transferor that transfers an image developed by the developer to a sheet-shaped printing medium.
